(19) United States
(12) Patent Application Publication
(10) Pub. No.: US 2024/0154186 A1
(43) Pub. Date: May 9, 2024

(54) LOW-VOLTAGE LITHIUM BATTERY CIRCUITRY AND PROTECTION METHOD FOR LOW-VOLTAGE LITHIUM BATTERY

(71) Applicants: Camel Group Wuhan Optics Valley R&D Center Co., Ltd., Wuhan (CN); Camel Group Co., Ltd., Xiangyang (CN)

(72) Inventors: Huan JIANG, Wuhan, Hubei (CN); Changlai LIU, Wuhan, Hubei (CN); Shizhong XIA, Wuhan, Hubei (CN); Nian CHEN, Wuhan, Hubei (CN)

(21) Appl. No.: 18/410,765

(22) Filed: Jan. 11, 2024

Related U.S. Application Data
(63) Continuation of application No. PCT/CN2022/133012, filed on Nov. 18, 2022.

(30) Foreign Application Priority Data
Oct. 20, 2022 (CN) 202211286681.3

(51) Int. Cl. H01M 10/42; B60R 16/033; H01M 10/0525; H01M 10/48; H02J 7/00

(52) U.S. Cl. CPC H01M 10/425; B60R 16/033; H01M 10/0525; H01M 10/482; H01M 10/486; H02J 7/0029; H02J 7/0047; H01M 2010/4271

(57) ABSTRACT

A low-voltage lithium battery circuitry includes a busbar, a battery signal transmitter unit, a battery management system, and a lithium battery module connected to the battery management system through the busbar and the battery signal transmitter unit. The lithium battery module is configured to provide energy for an external load and supply power to the battery management system. The battery management system is configured to monitor electrical parameters acquired in the lithium battery module and, when any one of the electrical parameters exceeds a protection threshold range corresponding thereto, perform a protection operation.

### CROSS-REFERENCE TO RELATED APPLICATIONS

This application is a continuation of International Application No. PCT/CN2022/133012, filed on Nov. 18, 2022, which claims priority to Chinese Patent Application No. 202211286681.3, filed on Oct. 20, 2022. The disclosures of the aforementioned applications are incorporated herein by reference in their entireties.

### TECHNICAL FIELD

The present disclosure relates to lithium-ion battery systems, and in particular, to a low-voltage lithium battery circuitry and a protection method for a low-voltage lithium battery.

### BACKGROUND

Low-voltage lead-acid batteries have been applied in the automobile industry for a long time and are one of the core components of automobiles. Such batteries are widely used in conventional fuel vehicles (generally a lead-acid battery for a passenger vehicle has a voltage of 12V and a lead-acid battery for a commercial vehicle has a voltage of 24V), providing energy sources of power supply for vehicle start-up, start & stop, low-voltage electronic components such as an electronic control unit (ECU), or the like.

With the development of automobiles towards electrification, intelligence and lightweight, requirements for intelligence and lightweight are put forward for the low-voltage batteries.

However, the lead-acid battery does not contain a battery management system (BMS) and thus cannot communicate with the vehicle, so that intelligent management cannot be achieved, which often leads to a problem that the vehicle cannot start-up due to undervoltage and insufficient power of the battery.

### SUMMARY

One or more embodiments of the present disclosure provide a low-voltage lithium battery circuitry including a busbar, a battery signal transmitter unit, a battery management system, and a lithium battery module. The battery signal transmitter unit is connected to each of the lithium battery module and the battery management system. The lithium battery module is connected to the battery management system through a first port of the busbar and a third port of the busbar. The battery management system is connected to a positive terminal of a battery system through a second port of the busbar and connected to a negative terminal of the battery system through a fourth port of the busbar, so as to supply power to an external load that is connected between the positive terminal of the battery system and the negative terminal of the battery system. The lithium battery module is configured to provide energy for the external load and supply power to the battery management system. The battery signal transmitter unit is configured to transmit electrical parameters acquired in the lithium battery module to the battery management system, where the electrical parameters include an internal total voltage signal, cell voltage signals, and battery temperature signals. The battery management system is configured to monitor the electrical parameters and, when any one of the electrical parameters exceeds a protection threshold range corresponding thereto, perform a protection operation.

In addition, one or more embodiments of the present disclosure further provide a protection method for a low-voltage lithium battery, applicable to a low-voltage lithium battery circuitry including a busbar, a battery signal transmitter unit, a battery management system, and a lithium battery module. The battery signal transmitter unit is connected to each of the lithium battery module and the battery management system. The lithium battery module is connected to the battery management system through a first port of the busbar and a third port of the busbar. The battery management system is connected to a positive terminal of a battery system through a second port of the busbar and connected to a negative terminal of the battery system through a fourth port of the busbar. The protection method includes: the lithium battery module acquiring electrical parameters in the lithium battery module, where the electrical parameters include an internal total voltage signal, cell voltage signals, and battery temperature signals; the battery signal transmitter unit transmitting the electrical parameters to the battery management system; and when any one of the electrical parameters exceeds a protection threshold range corresponding thereto, the battery management system performing a protection operation.

### BRIEF DESCRIPTION OF THE DRAWINGS

FIG. 1 is a schematic structure diagram of a low-voltage lithium battery circuitry according to one or more embodiments of the present disclosure.

FIG. 2 is a schematic circuit diagram of an example of the low-voltage lithium battery circuitry according to one or more embodiments of the present disclosure.

FIG. 3 is a schematic circuit diagram of another example of the low-voltage lithium battery circuitry according to one or more embodiments of the present disclosure.

FIG. 4 is a schematic flowchart of a protection method for a low-voltage lithium battery according to one or more embodiments of the present disclosure.

### DETAILED DESCRIPTION

Some embodiments of the present disclosure will be described in detail below with reference to the accompanying drawings. The embodiments are described for illustrative purposes only and are not intended to limit the present disclosure.

One or more embodiments of the present disclosure provide a low-voltage lithium battery circuitry which can implement all-weather monitoring and management of a voltage, a temperature, and current status of the battery. With the low-voltage lithium battery circuitry, a main loop composed of power metal-oxide-semiconductor field effect transistors (MOSFETs) can be used to independently control a charging loop and a discharging loop, thereby implementing main loop protection under any of the operating conditions of the battery pack such as overcharge, overdischarge, overtemperature, overcurrent, and the like.

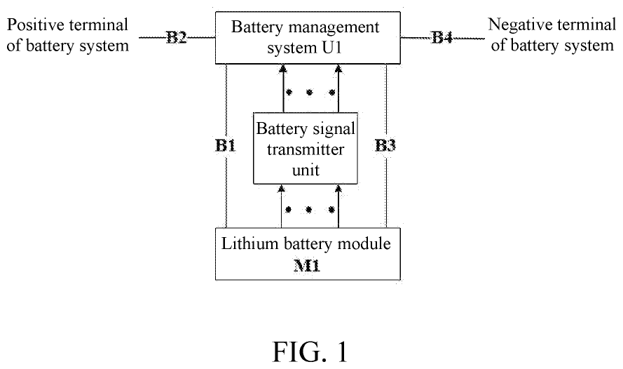

FIG. 1 is a schematic structure diagram of a low-voltage lithium battery circuitry according to one or more embodiments of the present disclosure. As shown in FIG. 1, the low-voltage lithium battery circuitry may include a busbar, a battery signal transmitter unit, a battery management system U1, and a lithium battery module M1.

The battery signal transmitter unit is connected to each of the lithium battery module M1 and the battery management system U1.

The lithium battery module M1 is connected to the battery management system U1 through a first port B1 and a third port B3 of the busbar. Thus, power loop connection of the lithium battery module M1 with the battery management system U1 is implemented through the first port B1 and the third port B3 of the busbar.

The battery management system U1 is connected to a positive terminal PACK+ of the battery system through a second port B2 of the busbar and connected to a negative terminal PACK− of the battery system through a fourth port B4 of the busbar, so as to supply power to an external load connected between the positive terminal PACK+ of the battery system and the negative terminal PACK− of the battery system.

The lithium battery module M1 can provide energy for the external load and supply power to the battery management system U1.

Electrical parameters acquired in the lithium battery module M1 can be transmitted to the battery management system U1 via the battery signal transmitter unit. The electrical parameters may include an internal total voltage signal Signal-BAT+, cell voltage signals, and battery temperature signals.

The battery management system U1 can monitor the electrical parameters and, if it is determined that any one of the electrical parameters exceeds a corresponding protection threshold range, perform a protection operation.

The ports B1 to B4 of the busbar are configured for electrical connection of the main loop, so as to ensure high-current flow capacity. The busbar includes, but is not limited to, a copper bar and an aluminium bar. The power loop is a circuit loop where a high current flows from a positive terminal to a negative terminal.

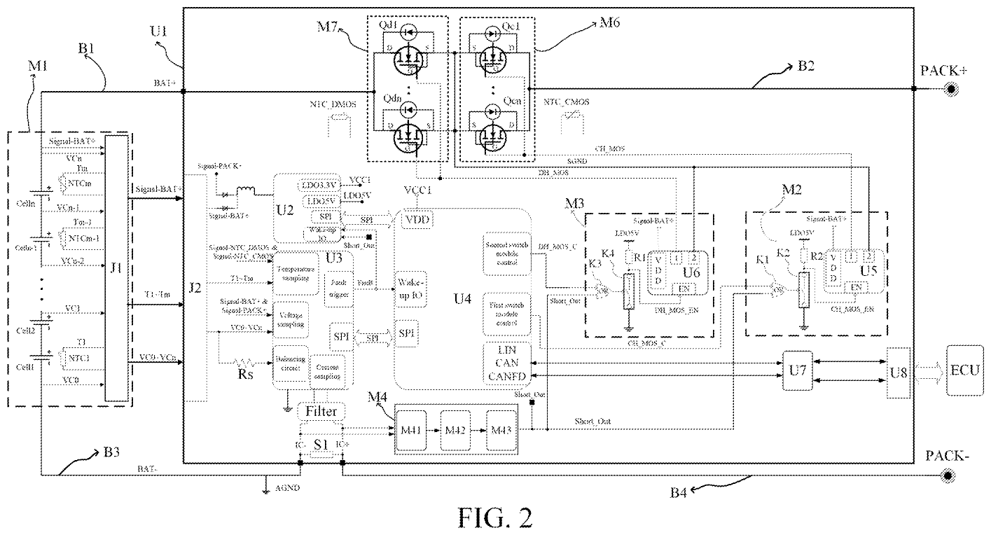

As shown in FIG. 2, the lithium battery module M1 includes:
n lithium-ion cells Cell1 to Celln (n≤8) sequentially connected in series;
m temperature sampling sensors NTC1 to NTCm; and a female sampling connector J1 including an internal total voltage signal acquisition terminal, n voltage signal acquisition terminals, and m temperature signal acquisition terminals, where each of n and m is a positive integer greater than 2,
where the internal total voltage signal acquisition terminal is connected to a sampling node on a positive terminal of a tail lithium-ion cell Celln of the n lithium-ion cells Cell1 to Celln, and is used to receive the internal total voltage signal Signal-BAT+ of the lithium battery module M1; the voltage signal acquisition terminals are respectively connected to a sampling node on a negative terminal of a head lithium-ion cell Cell1 of the n lithium-ion cells Cell1 to Celln and sampling nodes respectively on positive/negative terminals of intermediate lithium-ion cells Cell2 to Celln-1, and are used to receive respective cell voltage signals VC0 to VCn of the head lithium-ion cell Cell1 and the intermediate lithium-ion cells Cell2 to Celln-1; and
the temperature signal acquisition terminals are respectively connected to the temperature sampling sensors NTC1 to NTCm, and are used to receive battery temperature signals T1 to Tm respectively acquired by the temperature sampling sensors NTC1 to NTCm,
where each of the intermediate lithium-ion cells Cell2 to Celln-1 is one of the n lithium-ion cells Cell1 to Celln that is located between the tail lithium-ion cell Celln and the head lithium-ion cell Cell1.

In some embodiments, the m temperature sampling sensors include:
a head temperature sampling sensor NTC1 arranged around the negative terminal of the head lithium-ion cell Cell1 and configured to acquire a battery temperature signal T1 of the head lithium-ion cell Cell1;
a plurality of intermediate temperature sampling sensors NTC2 to NTCm-1 respectively arranged around respective negative terminals of (m-2) ones of the intermediate lithium-ion cells Cell2 to Celln-1 and configured to acquire respective battery temperature signals T2 to Tm-1 of the (m-2) intermediate lithium-ion cells; and
a tail temperature sampling sensor NTCm arranged around the positive terminal of the tail lithium-ion cell Celln and configured to acquire a battery temperature signal Tm of the tail lithium-ion cell Celln,
where each of the intermediate temperature sampling sensors NTC2 to NTCm-1 is one of the m temperature sampling sensors NTC1 to NTCm that is located between the tail temperature sampling sensor NTCm and the head temperature sampling sensor NTC1.

In some embodiments, the battery management system includes a male sampling connector J2, a sampling circuit U3, a microcontroller unit (MCU) module U4, and a communication device.

The male sampling connector J2 is connected to the female sampling connector J1 and configured to receive the internal total voltage signal Signal-BAT+, the cell voltage signals VC0 to VCn, and the battery temperature signals T1 to Tm.

The sampling circuit U3 is connected to the male sampling connector J2 and configured to: receive the internal total voltage signal Signal-BAT+, the cell voltage signals VC0 to VCn, and the battery temperature signals T1 to Tm; acquire a total voltage signal (including an external total voltage signal Signal-PACK+(not shown in the figure) and the internal total voltage signal Signal-BAT+), a current sampling signal, and a MOSFET temperature signal in the circuitry; and transmit the internal total voltage signal Signal-BAT+, the cell voltage signals VC0 to VCn, the total voltage signal (including the external total voltage signal Signal-PACK+ and the internal total voltage signal Signal-BAT+), the battery temperature signals T1 to Tm, the current sampling signal, and the MOSFET temperature signal to the MCU module U4 after collecting and filtering them.

The MCU module U4 is connected to the sampling circuit U3 and configured to generate a fault alarm signal when at least one of the following conditions is met:
any of the cell voltage signals VC0 to VCn being greater than an overvoltage threshold, the total voltage signal (including the external total voltage signal Signal-PACK+ and the internal total voltage signal Signal-BAT+) being greater than the overvoltage threshold, the internal total voltage signal Signal-BAT+ being greater than the overvoltage threshold, the internal total voltage signal Signal-BAT+ being less than an undervoltage threshold, any of the cell voltage signals VC0 to VCn being less than the undervoltage threshold, the total voltage signal (including the external total voltage signal Signal-PACK+ and the internal total voltage signal Signal-BAT+) being less than the undervoltage threshold, any of the battery temperature signals T1 to Tm being greater than a battery overtemperature threshold, the MOSFET temperature signal being greater than the battery overtemperature threshold, or the current sampling signal being greater than an overcurrent threshold.

The communication device including a communication transceiver U7 and a communication connector U8 establishes a bidirectional communication connection with each of the MCU module U4 and an electronic control unit of a vehicle through a communication bus, and is configured to send the fault alarm signal to the electronic control unit of the vehicle and receive a control signal from the electronic control unit of the vehicle to cause the MCU module U4 to update protection thresholds. The protection thresholds include the overcurrent threshold, the battery overtemperature threshold T0max, the overvoltage threshold, and the undervoltage threshold.

In some embodiments, the battery management system further includes a first switch module M6 and a second switch module M7.

When the lithium battery module M1 is in a charging state, the MCU module U4 will determine that charging overvoltage occurs and generate a charging overvoltage alarm signal when at least one of the following conditions is met: any of the cell voltage signals VC0 to VCn being greater than the overvoltage threshold, or the total voltage signal being greater than the overvoltage threshold.

The MCU module U4 is configured to, based on the charging overvoltage alarm signal, control the second switch module M7 to be turned on and control the first switch module M6 to be turned off, so that the main loop is turned off and prevented from charging, and the main loop enters a discharging maintaining state, thereby implementing an overcharge protection function.

In some embodiments, the battery management system further includes a first drive module M2 and a second drive module M3.

The second switch module M7 is connected to a positive terminal of the tail lithium-ion cell Celln through the first port B1 of the busbar.

The first switch module M6 is connected to the positive terminal PACK+ of the battery system through the second port B2 of the busbar.

The first drive module M2 is connected to a first switch module control terminal of the MCU module U4, and is configured to receive a first control signal CH_MOS_C generated by the MCU module U4, and output a first drive signal CH_MOS based on the first control signal CH_MOS_C.

The second drive module M3 is connected to a second switch module control terminal of the MCU module U4, and is configured to receive a second control signal DH_MOS_C generated by the MCU module U4, and output a second drive signal DH_MOS based on the second control signal DH_MOS_C.

The first switch module M6 is connected to the first drive module M2, and is configured to control a charging state of a circuit loop based on the first drive signal CH_MOS.

The second switch module M7 is connected to the second drive module M3, and is configured to control a discharging state of the circuit loop based on the second drive signal DH_MOS.

In some embodiments, the first switch module M6 includes a number of primary N-channel MOSFETs Qc1 to Qcn connected in parallel, and the second switch module M7 includes a number of secondary N-channel MOSFETs Qd1 to Qdn connected in parallel.

Drains D of the number of primary N-channel MOSFETs Qc1 to Qcn in the first switch module M6 are connected together and connected to the positive terminal PACK+ of the battery system.

Sources S of the number of primary N-channel MOSFETs Qc1 to Qcn in the first switch module M6 are connected together and connected to each of respective sources S of the number of secondary N-channel MOSFETs Qd1 to Qdn connected in parallel in the second switch module M7.

Gates G of the number of primary N-channel MOSFETs Qc1 to Qcn in the first switch module M6 are connected together and connected to the first drive module M2.

Drains D of the number of secondary N-channel MOSFETs Qd1 to Qdn in the second switch module M7 are connected together and connected through the first port B1 of the busbar.

Sources S of the number of secondary N-channel MOSFETs Qd1 to Qdn in the second switch module M7 are connected together and connected to each of the respective sources S of the number of primary N-channel MOSFETs Qc1 to Qcn connected in parallel in the first switch module M6.

Gates G of the number of secondary N-channel MOSFETs Qd1 to Qdn in the second switch module M7 are connected together and connected to the second drive module M3, where n is a positive integer greater than 2.

In some embodiments, the battery management system further includes a first drive module M2, a second drive module M3, a first switch module M6, and a second switch module M7, where the first switch module M6 includes a primary N-channel MOSFET and a secondary N-channel MOSFET that are connected in series, and the second switch module M7 includes a primary N-channel MOSFET and a secondary N-channel MOSFET that are connected in series.

A drain D of the primary N-channel MOSFET in the first switch module M6 is connected to a drain D of the primary N-channel MOSFET in the second switch module M7.

A source S of the primary N-channel MOSFET in the first switch module M6 is connected to a source S of the primary N-channel MOSFET in the second switch module M7.

A gate G of the primary N-channel MOSFET in the first switch module M6 and a gate G of the secondary N-channel MOSFET in the first switch module M6 are connected together and connected to the second drive module M3.

A gate G of the primary N-channel MOSFET in the second switch module M7 and a gate G of the secondary N-channel MOSFET in the second switch module M7 are connected together and connected to the first drive module M2.

In some embodiments, the battery management system further includes a short-circuit protection device M4.

The first drive module M2 is connected to each of the first switch module control terminal of the MCU module U4 and a signal output terminal of the short-circuit protection device M4, and is configured to receive the first control signal CH_MOS_C generated by the MCU module U4 and a latch signal Short_Out output from the short-circuit protection device M4, and output a first drive signal CH_MOS based on the first control signal CH_MOS_C and the latch signal Short_Out.

The second drive module M3 is connected to each of the second switch module control terminal of the MCU module U4 and the signal output terminal of the short-circuit protection device M4, and is configured to receive a second control signal DH_MOS_C generated by the MCU module U4 and the latch signal Short_Out output from the short-circuit protection device M4, and output a second drive signal DH_MOS based on the second control signal DH_MOS_C and the latch signal Short_Out.

In some embodiments, the battery management system further includes a shunt S1 and a filter. The short-circuit protection device M4 includes an operational amplifier unit M41, a comparator unit M42, and a signal latch unit M43.

A terminal IC− of the shunt S1 is connected to a negative terminal of the head lithium-ion cell Cell1 through the third port B3 of the busbar, and a terminal IC+ of the shunt S1 is connected to a negative terminal PACK− of the battery system through the fourth port B4 of the busbar, so as to output two current differential signals.

Two terminals of the filter are respectively connected to the terminals IC− and IC+ of the shunt S1, and the filter is configured to filter the two current differential signals to obtain the stable current sampling signal, and transmit the current sampling signal to a current sampling port of the sampling circuit U3, so as to determine, by comparing the current sampling signal with the overcurrent threshold, whether overcurrent occurs.

The operational amplifier unit M41 has two input terminals respectively connected to the terminals IC− and IC+ of the shunt S1, so as to amplify the two current differential signals.

The comparator unit M42 is connected to an output terminal of the operational amplifier unit M41, and is configured to perform comparison based on the amplified two current differential signals to output a comparison result.

The signal latch unit M43 is connected to the comparator unit M42 and configured to output the latch signal Short_Out based on the comparison result. The signal output terminal of the short-circuit protection device M4 is an output terminal of the signal latch unit M43.

In some embodiments, the battery management system further includes a system basis chip (SBC) power module U2.

A power supply input terminal of the SBC power module U2 receives each of the internal total voltage signal Signal-BAT+ provided by the male sampling connector J2 and the external total voltage signal Signal-PACK+ provided by the positive terminal PACK+ of the battery system.

A first power supply terminal LDO3.3V of the SBC power module U2 is connected to a power supply terminal of the MCU module U4, and is used to provide a first operating power supply VCC1 for the MCU module U4.

A second power supply terminal LDO5V of the SBC power module U2 is connected to each of the first drive module M2 and the second drive module M3, and is used to provide a second operating power supply 5V for each of the first drive module M2 and the second drive module M3.

A wake-up input/output (IO) port of the SBC power module U2 is connected to a fault trigger unit of the sampling circuit U3. When the wake-up IO port of the SBC power module U2 receives a fault wake-up signal Fault from the fault trigger unit, the SBC power module U2 is woken up.

The wake-up IO port of the SBC power module U2 is also connected to the signal latch unit M43 of the short-circuit protection device M4, and is used to receive the latch signal Short_Out from the signal latch unit M43.

The short-circuit protection device M4 is configured to maintain in an operating state during a sleep period of the SBC power module U2 and, upon triggering short-circuit protection, latch a protection state and send the latch signal Short_Out to the wake-up IO port to wake up the SBC power module U2 to enter an operating state.

In some embodiments, the first drive module M2 includes a first OR gate K1, a first pull-down switch K2, a first gate driver U5, and a first resistor R2. The second drive module M3 includes a second OR gate K3, a second pull-down switch K4, a second gate driver U6, and a second resistor R1.

A first input terminal of the second OR gate K3 is connected to a second switch module control terminal of the MCU module U4 to receive the second control signal DH_MOS_C, and a second input terminal of the second OR gate K3 is connected to the output terminal of the short-circuit protection device M4 to receive the latch signal Short_Out.

An output terminal of the second OR gate K3 is connected to a first terminal of the second pull-down switch K4. A second terminal of the second pull-down switch K4 is connected to the second operating power supply 5V through the second resistor R1, and a third terminal of the second pull-down switch K4 is grounded.

An enable control terminal EN of the second gate driver U6 is connected to a node between the second terminal of the second pull-down switch K4 and the second resistor R1 to receive a second enable signal DH_MOS_EN, and a power supply terminal VDD of the second gate driver U6 receives the internal total voltage signal Signal-BAT+.

A first control terminal of the second gate driver U6 is connected to the gate G of each of the secondary N-channel MOSFETs Qd1 to Qdn in the second switch module M7.

A second control terminal of the second gate driver U6 is connected to the source S of each of the secondary N-channel MOSFETs Qd1 to Qdn in the second switch module M7.

A first input terminal of the first OR gate K1 is connected to a first switch module control terminal of the MCU module U4 to receive the first control signal CH_MOS_C, and a second input terminal of the first OR gate K1 is connected to the output terminal of the short-circuit protection device M4 to receive the latch signal Short_Out.

An output terminal of the first OR gate K1 is connected to a first terminal of the first pull-down switch K2. A second terminal of the first pull-down switch K2 is connected to the second operating power supply 5V through the first resistor R2, and a third terminal of the first pull-down switch K2 is grounded.

An enable control terminal EN of the first gate driver U5 is connected to a node between the second terminal of the first pull-down switch K2 and the first resistor R2 to receive a first enable signal CH_MOS_EN, and a power supply terminal VDD of the first gate driver U5 receives the internal total voltage signal Signal-BAT+.

A first control terminal of the first gate driver U5 is connected to the gate G of each of the primary N-channel MOSFETs Qc1 to Qcn in the first switch module M6.

A second control terminal of the first gate driver U5 is connected to the source S of each of the primary N-channel MOSFETs Qc1 to Qcn in the first switch module M6.

In some embodiments, the first drive module M2 includes a first OR gate K1, a first pull-down switch K2, a first gate driver U5, and a first resistor R2. The second drive module M3 includes a second OR gate K3, a second pull-down switch K4, a second gate driver U6, and a second resistor R1.

A first input terminal of the second OR gate K3 is connected to a second switch module control terminal of the MCU module U4 to receive the second control signal DH_MOS_C, and a second input terminal of the second OR gate K3 is connected to the output terminal of the short-circuit protection device M4 to receive the latch signal Short_Out.

An output terminal of the second OR gate K3 is connected to a first terminal of the second pull-down switch K4. A second terminal of the second pull-down switch K4 is connected to the second operating power supply 5V through the second resistor R1, and a third terminal of the second pull-down switch K4 is grounded.

An enable control terminal EN of the second gate driver U6 is connected to a node between the second terminal of the second pull-down switch K4 and the second resistor R1 to receive a second enable signal DH_MOS_EN, and a power supply terminal VDD of the second gate driver U6 receives the internal total voltage signal Signal-BAT+.

A first control terminal of the second gate driver U6 is connected to a common gate of the primary N-channel MOSFET and the secondary N-channel MOSFET in the first switch module M6.

A second control terminal of the second gate driver U6 is connected to a common source of the primary N-channel MOSFET and the secondary N-channel MOSFET in the first switch module M6.

A first input terminal of the first OR gate K1 is connected to a first switch module control terminal of the MCU module U4 to receive the first control signal CH_MOS_C, and a second input terminal of the first OR gate K1 is connected to the output terminal of the short-circuit protection device M4 to receive the latch signal Short_Out.

An output terminal of the first OR gate K1 is connected to a first terminal of the first pull-down switch K2. A second terminal of the first pull-down switch K2 is connected to the second operating power supply 5V through the first resistor R2, and a third terminal of the first pull-down switch K2 is grounded.

An enable control terminal EN of the first gate driver U5 is connected to a node between the second terminal of the first pull-down switch K2 and the first resistor R2 to receive a first enable signal CH_MOS_EN, and a power supply terminal VDD of the first gate driver U5 receives the internal total voltage signal Signal-BAT+.

A first control terminal of the first gate driver U5 is connected to a common gate of the primary N-channel MOSFET and the secondary N-channel MOSFET in the second switch module M7.

A second control terminal of the first gate driver U5 is connected to a common source of the primary N-channel MOSFET and the secondary N-channel MOSFET in the second switch module M7.

In some embodiments, as shown in FIG. 2, independent on-off control can be implemented through the first switch module M6 and the second switch module M7. When charging overvoltage occurs, the charging loop can be turned off independently and the discharging loop remains normally turned-on, thereby implementing overcharge protection without affecting the discharge performance of the low-voltage lithium battery pack.

The battery management system U1 in the low-voltage lithium battery circuitry according to some embodiments of the present disclosure can implement monitoring and protection management of the battery and perform information communication with the vehicle, thereby achieving intelligent management. After the vehicle is powered off and enters a sleep state, the sampling circuit of the battery management system U1 in the low-voltage lithium battery circuitry can still periodically detect whether overcurrent, overtemperature, overvoltage or undervoltage fault occurs in the battery. If such a fault is detected, the sampling circuit can trigger a hard-wired signal to wake up the battery management system U1, which in turn wakes up the vehicle through communication, so as to perform corresponding fault protection. This can solve the battery safety problem during the vehicle is powered-off and sleeps.

For example, as shown in FIG. 2, a low-voltage lithium battery circuitry may include a battery module M1 composed of a plurality of lithium-ion cells connected in series, a busbar having ports B1 to B4, a female sampling connector J1, a male sampling connector J2, a communication device (including a communication transceiver U7 and a communication connector U8), an SBC power module U2, a sampling circuit U3, an MCU module U4, a first drive module M2, a second drive module M3, a first switch module M6, a second switch module M7, a short-circuit protection device M4, and a shunt S1.

The low-voltage lithium battery module M1 as a core module of the low-voltage lithium battery system is responsible for providing high-power energy for the main loop and providing an internal total voltage signal, cell voltage signals, and battery temperature sampling signals to the battery management system U1. The low-voltage lithium battery module M1 is composed of n lithium-ion cells connected in series (for example, when n=4, it is a 12 V battery system, and when n=8, it is a 24 V battery system), and may include, but is not limited to, a lithium iron phosphate battery pack, a ternary (NCM, NCA) lithium-ion battery pack, or the like.

A negative terminal of Cell1 in the low-voltage lithium battery module M1 is connected to a third port B3 of the busbar. The third port B3 is actually a battery negative terminal BAT− of the low-voltage lithium battery module M1, and the other terminal of the third port B3 is connected to a terminal IC− of the shunt S1 in the battery management system U1. A positive terminal of Cell1 is connected in series to a negative terminal of Cell2, and then sequentially connected in series to the tail cell Celln. A positive terminal of Celln is connected to a first port B1 of the busbar. The first port B1 is actually a battery positive terminal BAT+ of the low-voltage lithium battery module M1, and the other terminal of B1 is connected to a drain D of the second switch module M7 in U1.

To monitor and manage a voltage of each cell, it is necessary to acquire a cell voltage of each cell. Therefore, there is a sampling node welded on each of a negative terminal and a positive terminal of each of the cells Cell1 to Celln, where only one sampling node needs to be provided between any two adjacent cells. A cell voltage signal VC0 of Cell1 is sampled at a sampling node at a negative terminal of Cell1. A cell voltage signal VC1 of Cell1 is sampled at a sampling node at a connection node between a positive terminal of Cell1 and a negative terminal of Cell2, and so forth. At the end, a cell voltage signal VCn of Celln is sampled at a sampling node at a positive terminal of Celln. The signals VC0 to VCn can be transmitted to the female sampling connector J1 through a flexible printed circuit (FPC).

To supply power to the battery management system U1 so as to ensure the normal operation of U1, an internal total voltage signal Signal-BAT+ is also sampled at the positive terminal of Celln and transmitted to the female sampling connector J1 through the FPC.

To monitor and manage temperatures of the cells in the battery module, a plurality of temperature sampling sensors, for example, a plurality of negative temperature coefficient (NTC) sensors, are arranged in M1 (for example, 2 temperature sampling sensors are arranged for 12 V battery system composed of 4 cells connected in series, and 3 temperature sampling sensors are arranged for 24 V battery system composed of 4 cells connected in series), so as to acquire surface temperatures of the battery. For example, a first temperature sampling sensor is arranged next to the negative terminal of Cell1, a second temperature sampling sensor is arranged next to the negative terminal of Celln-1, and a third temperature sampling sensor is arranged next to the positive terminal of Celln. Each temperature sampling sensor has two sampling wires connected to the female sampling connector J1 through the FPC.

The female sampling connector J1 is plug-connected with the male sampling connector J2 of the battery management system U1. The battery management system U1 is the control and management center of the low-voltage lithium battery system. The battery management system U1 includes the shunt S1 on a negative loop, the first switch module M6 and the second switch module M7 on a positive main loop, the male sampling connector J2, the communication connector U8, the SBC power module U2, the sampling circuit U3, the MCU module U4, the communication transceiver U7, the first drive module M2, the second drive module M3, the short-circuit protection device M4, and the like.

In some embodiments, the shunt S1 is integrated and welded on the battery management system U1, and includes, but is not limited to, an alloy resistance shunt or a thin-film resistor. The terminal IC− of S1 is connected to the negative terminal of the head lithium-ion cell Cell1 through the third port B3 of the busbar, and the terminal IC+ of S1 is connected to the negative terminal PACK− of the battery system through the fourth port B4 of the busbar. A current differential signal sampling harness connected to both the terminal IC+ and the terminal IC− is connected to the filter. The filter performs RC filtering on the current differential signals to obtain stable sampling signals to the current sampling port of U3, thereby implementing current sampling signal acquisition. In addition, to implement a hardware short-circuit protection function, the current differential signal sampling harness is also connected to an input terminal of the operational amplifier unit M41 of M4.

A positive main loop switch in U1 is the key to control the main loop status of the entire battery system and implement fault protection. The main loop switch includes the first switch module M6 and the second switch module M7 that are connected in series. The first switch module M6 is composed of a plurality of N-MOSFETs connected in parallel. Each of the plurality of N-MOSFETs has a drain D connected to the positive terminal PACK+ of the battery system, a source S connected to a source S of the second switch module M7 through a connection node SGND as a drive grounded node of M6 and M7, and a gate G connected to a first control terminal of the first gate driver U5 in the first drive module M2 for receiving the CH_MOS signal used to control on/off of M6.

The second switch module M7 is composed of a plurality of N-MOSFETs connected in parallel. Each of the plurality of N-MOSFETs has a source S connected to the source S of M6 through the connection node SGND, a drain D connected to the battery positive terminal BAT+ through the first port B1 of the busbar, and a gate G connected to a first control terminal of the second gate driver U6 in the second drive module M3 for receiving the DH_MOS signal used to control on/off of M7.

The first drive module M2 is composed of an OR gate K1, a pull-down switch K2, an LDO5V constant power circuit, and a gate driver U5. U5 is a gate driver configured to control on/off of the first switch module M6, and is a core component of M2. U5 can be constantly powered from the battery positive terminal BAT+ through the first port B1 of the busbar, which can ensure that the MOSFETs are kept in a turned-on state even during the battery management system U1 sleeps. U5 has a first control terminal as a drive terminal connected to the gate G of M6, a second control terminal connected to the drive grounded node SGND of M6, and a drive enable EN terminal for receiving a signal CH_MOS_EN. The EN terminal is connected to the LDO5V constant power supply through a resistor and is connected to an output terminal of the pull-down switch K2. For example, when CH_MOS_EN=1 corresponding to a high level of 5 V is received through the EN terminal, U5 is enabled and the first control terminal outputs CH_MOS=1 corresponding to a high level of 12 V to control each of the MOSFETs in M6 to be turned on. When CH_MOS_EN=0 corresponding to a low level of 0 V is received through the EN terminal, U5 is disabled and the first control terminal outputs CH_MOS=0 corresponding to a low level of 0 V to control each of the MOSFETs in M6 to be turned off. An input terminal of the pull-down switch K2 is connected to an output terminal of the OR gate K1, and the output terminal of the pull-down switch K2 is connected in series to the LDO5V constant power supply through the resistor and can output signal CH_MOS_EN to the EN terminal of U5. Another terminal of K2 is grounded. K1 is a dual-channel OR gate, and has one input terminal for receiving the CH_MOS_C signal from a first switch module control terminal of the MCU module U4 and the other input terminal for receiving the signal Short_Out from the output terminal of the signal latch unit M43 of the short-circuit protection device M4. Thus, either of the MCU module U4 and the short-circuit protection device M4 can disable the drive signal of U5.

Similarly, the second drive module M3 is composed of an OR gate K3, a pull-down switch K4, an LDO5V constant power circuit, and a gate driver U6. U6 is a gate driver configured to control on/off of the second switch module M7, and is a core component of M3. U6 can be constantly powered from the battery positive terminal BAT+ through the first port B1 of the busbar, which can ensure that the MOSFETs are kept in a turned-on state even during the battery management system U1 sleeps. U6 has a first control terminal as a drive terminal connected to the gate G of M7, a second control terminal connected to the drive grounded node SGND of M7, and a drive enable EN terminal for receiving a signal DH_MOS_EN. The EN terminal is connected to the LDO5V constant power supply through a resistor and is connected to an output terminal of the pull-down switch K4. For example, when DH_MOS_EN=1 corresponding to a high level of 5 V is received through the EN terminal, U6 is enabled and the first control terminal outputs DH_MOS=1 corresponding to a high level of 12 V to control each of the MOSFETs in M7 to be turned on. When DH_MOS_EN=0 corresponding to a low level of 0 V is received through the EN terminal, U6 is disabled and the first control terminal outputs DH_MOS=0 corresponding to a low level of 0 V to control each of the MOSFETs in M7 to be turned off. An input terminal of the pull-down switch K4 is connected to an output terminal of the OR gate K3, and the output terminal of the pull-down switch K4 is connected in series to the LDO5V constant power supply through the resistor and can output signal DH_MOS_EN to the EN terminal of U6. Another terminal of K4 is grounded. K3 is a dual-channel OR gate, and has one input terminal for receiving the DH_MOS_C signal from a second switch module control terminal of the MCU module U4 and the other input terminal for receiving the signal Short_Out from the output terminal of the signal latch unit M43 of the short-circuit protection device M4. Thus, either of the MCU module U4 and the short-circuit protection device M4 can disable the drive signal of U6.

The short-circuit protection device M4 is composed of an operational amplifier unit M41, a comparator unit M42, and a signal latch unit M43. The current differential signals respectively at two terminals of the shunt S1 are transmitted to input terminals of the operational amplifier unit M41. After being amplified by the operational amplifier unit M41, the signals are sent to the comparator unit M42. The comparator unit M42 outputs a comparison result to the signal latch unit M43. The signal latch unit M43 then outputs a latch signal Short_Out to each of the OR gates K1 and K3. In addition, the latch signal Short_Out is transmitted to a wake-up IO port of the SBC power module U2 for waking up the SBC power module U2 when the battery management system U1 is in sleep, so as to wake up the battery management system U1 to enter an operating state.

The male sampling connector J2 is a signal connector in the battery management system U1, and is plug-connected with the female sampling connector J1 of the low-voltage lithium battery module ML.

The SBC power module U2 is responsible for power supply in the battery management system U1, and includes, but not limited to, a power supply integrated circuit (IC) chip, a DC-DC power supply, and a low-dropout regulator (LDO). Both the internal total voltage signal Signal-BAT+ from the connector J2 and the external total voltage signal Signal-PACK+ from the positive terminal PACK+ of the battery system connected to the second port B2 of the busbar are input to the power supply input terminal of U2. U2 can output power supply VCC1 signal to the MCU module U4 to supply power to the MCU module U4. In addition, U2 has an output power supply terminal LDO5V that can provide a constant power supply signal (configurable as enabled) and is connected to each of EN terminals of U5 and U6 in series through a resistor to supply a constant power high level signal to the gate driver EN terminals. U2 can communicate with U4 through a serial peripheral interface (SPI). The wake-up IO port of U2 can receive both a fault wake-up signal from a fault trigger unit of the sampling circuit U3 and a latch signal Short_Out from the short-circuit protection device M4, so that U2 supports wake-up by a fault trigger hard-wired signal from U3 or M4.

The sampling circuit U3 is responsible for sampling of voltage, current, and temperature signals of the battery, balancing control of the battery, and the like. The battery temperature signals T1 to Tm, acquired by the temperature sampling sensors NTCs, from the male sampling connector J2 are supplied to a temperature sampling circuit unit of U3. The cell voltage signals VC0 to VCn from the male sampling connector J2 are supplied to a voltage sampling circuit unit of U3, and supplied to a balancing circuit unit of U3 through a balancing resistor Rs so as to implement the balancing control of the battery.

A first temperature sampling sensor NTC_DMOS for acquiring a first MOSFET temperature signal Signal-NTC_DMOS and a second temperature sampling sensor NTC_CMOS for acquiring a second MOSFET temperature signal Signal-NTC_CMOS are arranged around M7 and M6, respectively. The first MOSFET temperature signal Signal-NTC_DMOS and the second MOSFET temperature signal Signal-NTC_CMOS are transmitted to the temperature sampling circuit unit of U3. Thus, sampling of the temperature of the MOSFET circuit can be implemented.

The internal total voltage signal Signal-BAT+ and the external total voltage signal Signal-PACK+ are transmitted to the voltage sampling circuit unit of U3 through the first port B1 and the second port B2 of the busbar, respectively, so as to implement sampling of the total voltage.

U3 has a terminal grounded, and the third port B3 of the busbar is also grounded via a grounded node AGND. U3 has a current sampling circuit unit that is connected to two terminals of the shunt through the filter to implement sampling of a bus current I. The fault trigger unit of U3 can output the fault wake-up signal Fault to the wake-up IO port of U2 and a wake-up IO port of U4. When Fault=1 (high level), hard-wired wake-up of U2 and U4 is implemented. SPI communication can be performed between U3 and U4 through an SPI port of U3 and an SPI port of U4, so as to implement parameter configuration and status setting for U3 and U4, and information exchange between U3 and U4.

The MCU module U4 is a control center of the battery management system U1 responsible for fault diagnosis, internal and external communication, MOSFET control, and the like. The MCU module U4 has a power supply terminal VDD, the SPI port, the first switch module control terminal, the second switch module control terminal, and a LIN (Local Interconnect Network)/CAN (Controller Area Network)/CANFD (CAN with Flexible Data rate) communication unit. The power supply terminal VDD can receive the power supply VCC1 signal from U2 to implement power supply to U4. The first switch module control terminal can output the first control signal CH_MOS_C to the OR gate K1. The second switch module control terminal can output the second control signal DH_MOS_C to the OR gate K2. The LIN/CAN/CANFD communication unit is connected to the communication transceiver U7 to implement LIN/CAN/CANFD communication.

The communication transceiver U7 is disposed between the communication connector U8 and the MCU module U4, and can convert a signal output from the MCU module U4 and transmit the converted signal to the ECU of the vehicle via the communication connector U8, so as to implement communication with the vehicle and a wake-up function.

In the above embodiments, the low-voltage lithium battery module M1 can supply power to the external load through the positive terminal PACK+ and the negative terminal PACK− of the battery system, thereby implementing the same power supply function as the lead-acid battery. The SBC power module U2 can supply power for operations within the battery management system U1. The sampling circuit U3 can acquire a main loop current I through the shunt S1 and acquire voltage data, temperature data and the like of the battery system. The MCU module U4 can control the first drive module M2 and the second drive module M3 based on the data acquired by U3, to implement on-off control of the switch modules. In addition, the MCU module U4 can perform information exchange and mutual wake-up with the ECU of the vehicle. The short-circuit protection device M4 can implement protection against an instantaneous high current caused by an abnormality such as external short-circuit or the like.

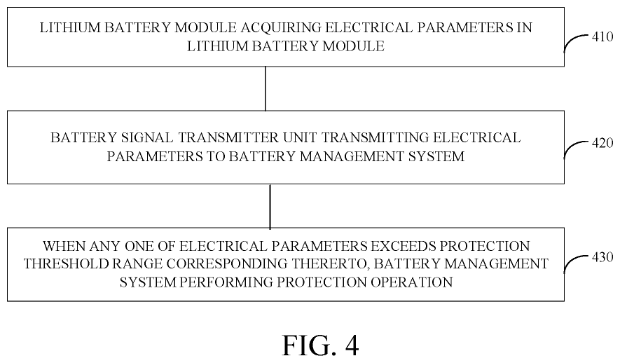

In some embodiments, a protection method for a low-voltage lithium battery, applicable to the low-voltage lithium battery circuitry according to any of the above embodiments, is provided. As shown in FIG. 4, the protection method may include operations 410-430.

In operation 410, electrical parameters in the lithium battery module M1 are acquired by the lithium battery module M1. The electrical parameters include an internal total voltage signal Signal-BAT+, cell voltage signals, and battery temperature signals.

In operation 420, the battery signal transmitter unit transmits the electrical parameters acquired in the lithium battery module M1 to the battery management system U1. In addition, the sampling circuit U3 of the battery management system U1 may acquire an external total voltage signal Signal-PACK+, a first MOSFET temperature signal Signal-NTC_DMOS and a second MOSFET temperature signal Signal-NTC_CMOS.

In operation 430, when any one of the electrical parameters exceeds a protection threshold range corresponding thereto, the battery management system U1 performs a protection operation.

In some embodiments, the battery management system includes an MCU module U4 and a communication device.

The MCU module U4 is configured to generate a fault alarm signal when at least one of the following conditions is met: any of the cell voltage signals VC0 to VCn being greater than an overvoltage threshold, the total voltage signal being greater than the overvoltage threshold, any of the cell voltage signals VC0 to VCn being less than an undervoltage threshold, the total voltage signal being less than the undervoltage threshold, any of the battery temperature signals T1 to Tm being greater than a battery overtemperature threshold, the MOSFET temperature signal being greater than the battery overtemperature threshold, or the current sampling signal being greater than an overcurrent threshold.

The communication device including U7 and U8 establishes a bidirectional communication connection with each of the MCU module U4 and an electronic control unit of the vehicle through a communication bus, and is configured to send the fault alarm signal to the electronic control unit and receive a control signal from the electronic control unit so that the MCU module U4 updates the protection thresholds including the overcurrent threshold, the battery overtemperature threshold, the overvoltage threshold, and the undervoltage threshold.

As an example, a protection method for a low-voltage lithium battery may include steps as follows.

1. The vehicle is powered on, and its ECU wakes up the communication transceiver U7 through LIN/CAN/CANFD communication. U7 wakes up SBC power module U2 and MCU module U4 of the battery management system U1. After initialized, the MCU module U4 configures protection thresholds such as overcurrent threshold IO, short-circuit threshold Ishort, battery overtemperature threshold T0max, overvoltage threshold U0max, undervoltage threshold U0min and the like. The battery management system U1 enters the normal operating state, and the lithium battery system normally discharges.

2. If no fault occurs, modules of the battery management system U1 perform information exchange therebetween normally, and the battery management system U1 exchanges information with the vehicle.

3. When the MCU module U4 determines that one of the sampled current I data, the sampled temperature T data, and the sampled voltage U data received from U3 exceeds a range of one of the set thresholds I0, T0max, and U0min corresponding thereto, the MCU module U4 determines that one of an overcurrent (OC) fault, a battery overtemperature (OT) fault, and an undervoltage (UV) fault has occurred, and thus activates a protection strategy corresponding thereto. Then, the MCU module U4 outputs high-level control signals CH_MOS_C=1 and DH_MOS_C=1 to change a level at each of the respective enable EN terminals of U5 and U6 to a low level (CH_MOS_EN=0, DH_MOS_EN=0), so as to control both the first switch module M6 and the second switch module M7 to be turned off (CH_MOS=0, DH_MOS=0). In this case, the main loop is turned off, and the lithium battery enters a protection state from a normal discharging state to stop power supply to the external.

4. When the lithium battery is in a charging state:
a. When the MCU module U4 determines that the sampled voltage U data received from U3 exceeds the set overvoltage threshold U0max, the MCU module U4 determines that a charging overvoltage (0V) fault has occurred, and thus activates a protection strategy corresponding thereto. Then, the MCU module U4 controls the first switch module control terminal to output a high-level control signal CH_MOS_C=1 to change a level at the enable EN terminal of U5 to a low level (CH_MOS_EN=0), so as to control the first switch module M6 to be turned off (CH_MOS=0). In this case, the loop is prevented from being charged, and the second switch module M7 remains at a turned-on state. Because in each of the MOSFETs of M6 there is a body diode having a one-way conduction characteristic, a discharge current can flow through the body diode and the loop can discharge. Thus, the charging-disabled and discharging-enabled function of the main loop can be implemented. The disabled charging function can be restored. When U3 detects a discharge current in the main loop that is greater than a preset threshold, the MCU module U4 determines that the system has changed to a normal discharging state, and immediately controls the first switch module control terminal to output a low-level control signal CH_MOS_C=0 to change a level at the enable EN terminal of U5 to a high level (CH_MOS_EN=1), so that the first switch module M6 is turned on. In this case, the main loop is completely turned on, and the lithium battery returns to the normal discharging state.
b. When the MCU module U4 determines that one of the sampled current I data and the sampled temperature T data received from U3 exceeds the set IO or T0max, the MCU module U4 determines that the overcurrent (OC) fault or the battery overtemperature (OT) fault has occurred, and thus activates a protection strategy so that the first switch module M6 and the second switch module M7 are turned off. The operations are the same as those in step 3 and thus are not repeated here.

5. When the vehicle is powered off and enters a sleep state (that is, a parking condition), the ECU of the vehicle sends a sleep instruction to the MCU module U4 in the battery management system U1 through the communication device. After completing status check and data storage, the MCU module U4 sends a sleep instruction to U2 and U3 through SPI communication. Then, U2 disables most of its functions and starts an internal timer, but maintains output of an LDO5V constant power signal to supply power to the drive modules M2 and M3 during the sleep period, to ensure that the first switch module M6 and the second switch module M7 maintain in the turned-on state. After the power supply such as VCC1 is turned off, the modules such as U3 and U4 are powered off and enter the sleep state. U3 will disable some of its functions but maintain detection of states such as overvoltage, undervoltage, overtemperature, overcurrent, and the like. In this case, most of the modules of the battery management system U1 do not operate and enter the sleep state. In this state, the power consumption is relatively low, which is beneficial to reduction of the power consumption of the lithium battery.
c. To enhance safety monitoring and protection performance of the lithium battery, a strategy of periodic wake-up of the battery management system U1 during the sleep period can be adopted. More specifically, during the sleep period of the battery management system U1, if no abnormality is detected by the sampling circuit U3 and the timer in U2 reaches a set threshold t0, U2 is woken up and enters a normal operating state. After U2 resumes power supply to the modules such as U4, the modules are also woken up, and the MCU module U4 then wakes up the sampling circuit U3. In this case, the entire battery management system U1 is woken up and enters the normal operating state. During this period, the MCU module U4 completes data acquisition and status diagnosis with respect to a voltage, a current and a temperature of the battery, and status of the MOSFETs, and stores related data. If everything is normal, the MCU module U4 sends a sleep instruction again so that U2, U3 and U4 enter the sleep state one after another. When the timer in U2 reaches the next threshold t0, the battery management system U1 will be woken up again. In this way, periodic wake-up and sleep are implemented. After the battery management system U1 is woken up, if the MCU module U4 detects that the battery voltage U is lower than the undervoltage threshold U0min, the MCU module U4 determines that the battery is of undervoltage, and immediately enables an intelligent power replenishment function. In this case, the MCU module U4 in the battery management system U1 sends an instruction to the ECU of the vehicle through U7 and U8 for waking up the ECU to operate. Then, the MCU module U4 sends a charging request signal, and charging voltage and current threshold parameters to the ECU. After receiving them, the ECU of the vehicle sets a charging ECU state to charge the low-voltage lithium battery. The intelligent power replenishment function can prevent the low-voltage lithium battery from an insufficient power and overdischarge fault during the sleep period.
d. During the sleep period of the battery management system U1, the sampling circuit U3 disables some of its functions but maintains detection of states such as overvoltage, undervoltage, overtemperature, overcurrent, and the like. When the sampling circuit U3 determines that one of the sampled voltage U data, the sampled current I data, and the sampled temperature T data exceeds a range of one of the set thresholds U0max, U0min, IO, and T0max corresponding thereto, the sampling circuit U3 determines that one of an overvoltage (0V) fault, an undervoltage (UV) fault, an overcurrent (OC) fault, and a battery overtemperature (OT) fault has occurred, and thus activates a protection strategy. In this case, a hard-wired signal in the fault trigger unit of U3 changes to a fault wake-up signal of a high level (Fault=1), and this signal immediately wakes up U2 and U4 through the wake-up IO port, such that the battery management system U1 is woken up. After detecting Fault=1, the MCU module U4 determines a fault state based on the sampled data sent by U3. If the fault is undervoltage (UV), the MCU module U4 will immediately enable the intelligent power replenishment function as in the above step c. If the fault is overcurrent (OC), the MCU module U4 will notify the ECU of the vehicle, through the communication device, that the load current consumption is abnormal and corresponding diagnosis and protection are needed. If the fault is overvoltage (0V) or overtemperature (OT), the MCU module U4 will activate an overvoltage or overtemperature protection strategy as in the above step 3.

6. The short-circuit protection device M4 in the battery management system U1 always maintains in an operating state during the operating and sleep periods of the battery management system U1. The short-circuit protection device M4 has a protection logic of as follows. A current I signal acquired by the shunt S1 is transmitted to the operational amplifier unit M41 in M4 for amplification. If a current sample value output from the operational amplifier unit M41 is greater than the short-circuit threshold Ishort in the comparator unit M42, the comparator unit M42 outputs a high-level signal to the latch unit for latching, and then the latch unit outputs a latch signal of a high level (Short_Out=1). Thus, the OR gate in each of M2 and M3 immediately outputs a high-level signal, so that a level at each of the respective EN terminals of U5 and U6 is changed to a low level (CH_MOS_EN=0, DH_MOS_EN=0), thereby controlling both the first switch module M6 and the second switch module M7 to be turned off (CH_MOS=0, DH_MOS=0). In this case, the main loop is turned off and enters a short-circuit protection state. This short-circuit protection function has a response speed on the order of microseconds, which is much higher than a response speed of the software overcurrent protection of the MCU module U4. In addition, the short-circuit protection device can still trigger the short-circuit protection immediately even during the sleep period of the battery management system U1, thereby implementing constant all-weather instantaneous high-current protection. This function can prevent the lithium battery from safety risks caused by abnormalities such as external short-circuit, reverse connection and the like, thereby improving the system security.

As described above, in one or more embodiments of the present disclosure, the main loop of a low-voltage lithium battery system can maintain in a turned-on state under a normal condition (with no fault) to ensure power supply to the external load. The internal first drive module M2 and second drive module M3 are powered by the internal total voltage of the battery pack in order to provide drive signals the switch modules of the main loop MOS during the operating and sleep periods of the battery management system U1.

The low-voltage lithium battery system can implement fault protection by the switch modules of the main loop. Each of the switch module may be composed of a number of N-channel MOSFETs connected in parallel. The number of the N-channel MOSFETs may be increased or decreased according to current flow capacity required by the main loop as to implement flexible configuration. The first drive module M2 and the second drive module M3 can respectively control the first switch module and the second switch module, thereby implementing independent control of each of the charging and discharging loops. When charging overvoltage occurs, the charging loop can be turned off separately, and the discharging loop can remain turned on. The charging MOSFETs can discharge due to the presence of the body diode, such that the discharging loop maintains in a turned-on state. Thus, overcharge protection can be implemented without affecting the discharge performance of the low-voltage lithium battery pack.

A periodic wake-up strategy can be configured for the battery management system U1. After the vehicle is powered off and enters the sleeps state, the battery management system U1 can be regularly woken up through the periodic wake-up function, without powering on the vehicle for operating, to regularly monitor status of the low-voltage lithium battery, thereby improving battery safety. In addition, the sleep duration of the battery management system U1 can be configured by software, which increases flexibility.

The battery management system U1 can still monitor abnormal operating conditions of the battery such as overvoltage, undervoltage, overtemperature, and overcurrent during the sleep period. The sampling circuit U3 can implement fault trigger based on the set 0V, UV, OT, and OC thresholds to wake up the power module U2 and the MCU module U4 by a hard-wired signal, so as to wake up the entire battery management system U1, thereby implementing fault monitoring during the sleep period.

The shunt is used for current acquisition, and can be integrated in the battery management system U1. Both the sampling circuit U3 and the short-circuit protection device M4 can acquire current data. U3 can be configured with different thresholds through software to implement a software overcurrent protection function. M4 can implement an instantaneous high-current overcurrent protection function (that is, short-circuit protection) through a hardware analog circuit. The short-circuit protection device M4 contains the latch unit M43 which can latch a signal triggered by short-circuit, thereby implementing circuit protection by turning off the charging and discharging MOSFETs.

The shunt and switch modules of the main loop can be integrated in the battery management system U1 to achieve a high integration degree. The charging MOSFETs and the discharging MOSFETs can be controlled independently, thereby implementing independent overcharge protection but not affecting discharging.

The battery management system U1 can be woken up periodically, and the sampling circuit can still monitor the voltage, temperature, and current sampling signals of the lithium battery during the sleep period. If any one of them exceeds a threshold corresponding thereto, the battery management system U1 can be woken up by hardware, which greatly improves the safety of the system.

With the intelligent power replenishment function, after detecting undervoltage of the battery during the sleep period, the battery management system U1 can wake up the ECU of the vehicle through communication to charge the low-voltage lithium battery, thereby implementing intelligent power replenishment and greatly reducing a probability of insufficient power of the battery due to long-term sleep.

With the hardware short-circuit protection function, constant instantaneous high-current protection can be implemented, thereby preventing the lithium battery from safety risks caused by short-circuit and greatly improving the system safety.

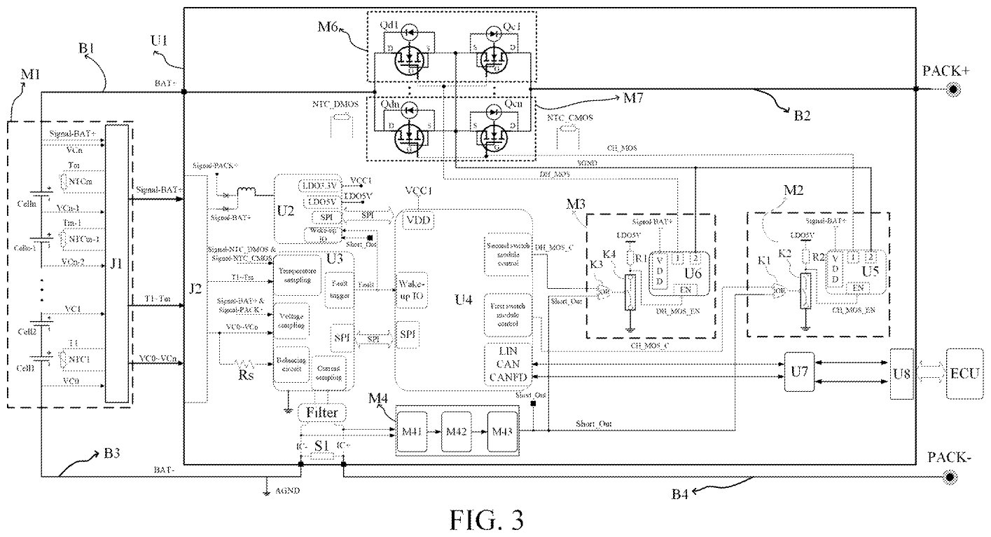

The another example of the low-voltage lithium battery circuitry as shown in FIG. 3 differs from the example thereof as shown in FIG. 2 in: the switch module M6 is composed of MOSFETs Qc1 and Qd1, the respective gates G of which are connected together and connected to the drive terminal of U6; and the switch module M7 is composed of MOSFETs Qcn and Qdn, the respective gates G of which are connected together and connected to the drive terminal of U5.

In the another example as shown in FIG. 3, the pair of the MOSFETs in each of M6 and M7 can only be turned off or turned on simultaneously, so that independent control of each of a charging switch and a discharging switch as in the example as shown in FIG. 2 cannot be implemented. Thus, if overcharge occurs during charging, it is impossible to turn off only the charging switch while maintaining the discharging function, that is, it is impossible to disable charging while enabling discharging.

On the other hand, the another example as shown in FIG. 3 has an advantage as follows. M6 and M7 may bypass each other. One module such as M6 may be turned off, and the other such as M7 may be kept turned on. In the case of ensuring normal power supply of the main loop, fault diagnosis can be performed on the MOSFETs in the turned-off module such as M6, which improves the feasibility of MOSFET state diagnosis.

Some embodiments of the present disclosure have been described in detail above. The description of the above embodiments merely aims to help to understand the present disclosure. Many modifications or equivalent substitutions with respect to the embodiments may occur to those of ordinary skill in the art based on the present disclosure. Thus, these modifications or equivalent substitutions shall fall within the scope of the present disclosure.

What is claimed is:

1. A low-voltage lithium battery circuitry, comprising: a busbar, a battery signal transmitter unit, a battery management system, and a lithium battery module,
wherein the battery signal transmitter unit is connected to each of the lithium battery module and the battery management system;
the lithium battery module is connected to the battery management system through a first port of the busbar and a third port of the busbar;
the battery management system is connected to a positive terminal of a battery system through a second port of the busbar and connected to a negative terminal of the battery system through a fourth port of the busbar, so as to supply power to an external load that is connected between the positive terminal of the battery system and the negative terminal of the battery system;
the lithium battery module is configured to provide energy for the external load and supply power to the battery management system;
the battery signal transmitter unit is configured to transmit electrical parameters acquired in the lithium battery module to the battery management system, wherein the electrical parameters comprise an internal total voltage signal, cell voltage signals, and battery temperature signals; and
the battery management system is configured to monitor the electrical parameters and, in response to determining that any one of the electrical parameters exceeds a protection threshold range corresponding to the any one of the electrical parameters, perform a protection operation.

2. The low-voltage lithium battery circuitry according to claim 1, wherein the lithium battery module comprises:
n lithium-ion cells sequentially connected in series;
m temperature sampling sensors; and
a female sampling connector comprising an internal total voltage signal acquisition terminal, n voltage signal acquisition terminals, and m temperature signal acquisition terminals, where each of n and m is a positive integer greater than 2,
wherein the internal total voltage signal acquisition terminal is connected to a sampling node on a positive terminal of a tail lithium-ion cell of the n lithium-ion cells, to receive the internal total voltage signal of the lithium battery module;
the n voltage signal acquisition terminals are respectively connected to a sampling node on a negative terminal of a head lithium-ion cell of the n lithium-ion cells and sampling nodes respectively on positive/negative terminals of intermediate lithium-ion cells of the n lithium-ion cells, to receive the cell voltage signals of the head lithium-ion cell and the intermediate lithium-ion cells;
the m temperature signal acquisition terminals are respectively connected to the m temperature sampling sensors, to receive the battery temperature signals respectively acquired by the m temperature sampling sensors; and
each of the intermediate lithium-ion cells is one of the n lithium-ion cells that is located between the tail lithium-ion cell and the head lithium-ion cell.

3. The low-voltage lithium battery circuitry according to claim 2, wherein the m temperature sampling sensors comprise:
a head temperature sampling sensor arranged around the negative terminal of the head lithium-ion cell and configured to acquire a battery temperature signal of the head lithium-ion cell;
a plurality of intermediate temperature sampling sensors respectively arranged around respective negative terminals of ones of the intermediate lithium-ion cells and configured to acquire respective battery temperature signals of the ones of the intermediate lithium-ion cells; and
a tail temperature sampling sensor arranged around the positive terminal of the tail lithium-ion cell and configured to acquire a battery temperature signal of the tail lithium-ion cell,
wherein each of the intermediate temperature sampling sensors is one of the m temperature sampling sensors that is located between the tail temperature sampling sensor and the head temperature sampling sensor.

4. The low-voltage lithium battery circuitry according to claim 2, wherein the battery management system comprises a male sampling connector, a sampling circuit, a microcontroller unit (MCU) module, and a communication device,
wherein the male sampling connector is connected to the female sampling connector, to receive the internal total voltage signal, the cell voltage signals, and the battery temperature signals;
the sampling circuit is connected to the male sampling connector and configured to: receive the internal total voltage signal, the cell voltage signals, and the battery temperature signals; acquire a total voltage signal, a current sampling signal, and a metal-oxide-semiconductor field effect transistor (MOSFET) temperature signal in the low-voltage lithium battery circuitry; and transmit the internal total voltage signal, the cell voltage signals, the total voltage signal, the battery temperature signals, the current sampling signal, and the MOSFET temperature signal to the MCU module after collecting and filtering the internal total voltage signal, the cell voltage signals, the total voltage signal, the battery temperature signals, the current sampling signal, and the MOSFET temperature signal;
the MCU module is connected to the sampling circuit and configured to generate a fault alarm signal in response to determining at least one of: any of the cell voltage signals being greater than an overvoltage threshold, the total voltage signal being greater than the overvoltage threshold, the internal total voltage signal being greater than the overvoltage threshold, the internal total voltage signal being less than an undervoltage threshold, any of the cell voltage signals being less than the undervoltage threshold, the total voltage signal being less than the undervoltage threshold, any of the battery temperature signals being greater than a battery overtemperature threshold, the MOSFET temperature signal being greater than the battery overtemperature threshold, or the current sampling signal being greater than an overcurrent threshold; and
the communication device is configured to establish a bidirectional communication connection with each of the MCU module and an electronic control unit of a vehicle through a communication bus, and is configured to send the fault alarm signal to the electronic control unit and receive a control signal from the electronic control unit of the vehicle to cause the MCU module to update protection thresholds comprising the overcurrent threshold, the battery overtemperature threshold, the overvoltage threshold, and the undervoltage threshold.

5. The low-voltage lithium battery circuitry according to claim 4, wherein the battery management system further comprises a first switch module and a second switch module; and
when the lithium battery module is in a charging state, the MCU module is configured to:
in response to determining at least one of: any of the cell voltage signals being greater than the overvoltage threshold, or the total voltage signal being greater than the overvoltage threshold, determine that charging overvoltage has occurred and generate a charging overvoltage alarm signal; and
control, based on the charging overvoltage alarm signal, the second switch module to be turned on and the first switch module to be turned off, so that a main loop is turned off and prevented from charging and enters a discharging maintaining state to implement an overcharge protection function.

6. The low-voltage lithium battery circuitry according to claim 5, wherein the battery management system further comprises a first drive module and a second drive module;
the second switch module is connected to the positive terminal of the tail lithium-ion cell through the first port of the busbar;
the first switch module is connected to the positive terminal of the battery system through the second port of the busbar;
the first drive module is connected to a first switch module control terminal of the MCU module to receive a first control signal generated by the MCU module, and is configured to output a first drive signal based on the first control signal;
the second drive module is connected to a second switch module control terminal of the MCU module to receive a second control signal generated by the MCU module, and is configured to output a second drive signal based on the second control signal;
the first switch module is connected to the first drive module, and is configured to control a charging state of a circuit loop based on the first drive signal; and
the second switch module is connected to the second drive module, and is configured to control a discharging state of the circuit loop based on the second drive signal.

7. The low-voltage lithium battery circuitry according to claim 6, wherein the first switch module comprises a number of primary N-channel MOSFETs connected in parallel, and the second switch module comprises a number of secondary N-channel MOSFETs connected in parallel;
respective drains of the number of primary N-channel MOSFETs in the first switch module are connected together and connected to the positive terminal of the battery system;
respective sources of the number of primary N-channel MOSFETs in the first switch module are connected together and connected to each of respective sources of the number of secondary N-channel MOSFETs connected in parallel in the second switch module;
respective gates of the number of primary N-channel MOSFETs in the first switch module are connected together and connected to the first drive module;
respective drains of the number of secondary N-channel MOSFETs in the second switch module are connected together and connected through the first port of the busbar; and
respective gates of the number of secondary N-channel MOSFETs in the second switch module are connected together and connected to the second drive module.

8. The low-voltage lithium battery circuitry according to claim 4, wherein the battery management system further comprises a first drive module, a second drive module, a first switch module, and a second switch module;
the first switch module comprises a primary N-channel MOSFET and a secondary N-channel MOSFET that are connected in series, and the second switch module comprises a primary N-channel MOSFET and a secondary N-channel MOSFET that are connected in series;
a drain of the primary N-channel MOSFET in the first switch module is connected to a drain of the primary N-channel MOSFET in the second switch module;
a source of the primary N-channel MOSFET in the first switch module is connected to a source of the primary N-channel MOSFET in the second switch module;
a gate of the primary N-channel MOSFET in the first switch module and a gate of the secondary N-channel MOSFET in the first switch module are connected together and connected to the second drive module; and
a gate of the primary N-channel MOSFET in the second switch module and a gate of the secondary N-channel MOSFET in the second switch module are connected together and connected to the first drive module.

9. The low-voltage lithium battery circuitry according to claim 7, wherein the battery management system further comprises a short-circuit protection device;
the first drive module is connected to each of the first switch module control terminal of the MCU module and an output terminal of the short-circuit protection device to receive the first control signal generated by the MCU module and a latch signal output from the short-circuit protection device, and is configured to output a first drive signal based on the first control signal and the latch signal; and
the second drive module is connected to each of the second switch module control terminal of the MCU module and the output terminal of the short-circuit protection device to receive the second control signal generated by the MCU module and the latch signal output from the short-circuit protection device, and is configured to output a second drive signal based on the second control signal and the latch signal.

10. The low-voltage lithium battery circuitry according to claim 9, wherein the battery management system further comprises a shunt and a filter;
the shunt has a first terminal connected to the negative terminal of the head lithium-ion cell through the third port of the busbar, and a second terminal connected to the negative terminal of the battery system through the fourth port of the busbar, to output two current differential signals; and
the filter has two terminals respectively connected to the first terminal and the second terminal of the shunt, and is configured to filter the two current differential signals to obtain the current sampling signal, and transmit the current sampling signal to a current sampling port of the sampling circuit, so as to determine, by comparing the current sampling signal with the overcurrent threshold, whether overcurrent has occurred.

11. The low-voltage lithium battery circuitry according to claim 10, wherein the short-circuit protection device comprises an operational amplifier unit, a comparator unit, and a signal latch unit;
the operational amplifier unit has two input terminals respectively connected to the first terminal and the second terminal of the shunt, and is configured to amplify the two current differential signals;
the comparator unit is connected to an output terminal of the operational amplifier unit, and is configured to perform comparison based on the amplified two current differential signals to output a comparison result; and
the signal latch unit is connected to the comparator unit and configured to output, from an output terminal as the output terminal of the short-circuit protection device, the latch signal based on the comparison result.

12. The low-voltage lithium battery circuitry according to claim 11, wherein the battery management system further comprises a system basis chip (SBC) power module;
the SBC power module has a power supply input terminal for receiving each of the internal total voltage signal provided by the male sampling connector and an external total voltage signal provided by the positive terminal of the battery system;
the SBC power module has a first power supply terminal connected to a power supply terminal of the MCU module, to provide a first operating power supply for the MCU module;
the SBC power module has a second power supply terminal connected to each of the first drive module and the second drive module, to provide a second operating power supply for each of the first drive module and the second drive module;
the SBC power module has a wake-up input/output (IO) port that is connected to a fault trigger unit of the sampling circuit to receive a fault wake-up signal from the fault trigger unit for waking up the SBC power module and that is further connected to the signal latch unit of the short-circuit protection device to receive the latch signal from the signal latch unit; and
the short-circuit protection device is configured to: during a sleep period of the SBC power module, maintain in an operating state and, upon triggering short-circuit protection, send the latch signal to the wake-up IO port for waking up the SBC power module to enter an operating state.

13. The low-voltage lithium battery circuitry according to claim 8, wherein the first drive module comprises a first OR gate, a first pull-down switch, a first gate driver, and a first resistor;
the second drive module comprises a second OR gate, a second pull-down switch, a second gate driver, and a second resistor;
the second OR gate has a first input terminal connected to a second switch module control terminal of the MCU module to receive a second control signal, a second input terminal connected to an output terminal of a short-circuit protection device to receive a latch signal, and an output terminal connected to a first terminal of the second pull-down switch;
the second pull-down switch has a second terminal connected to a second operating power supply through the second resistor, and a third terminal grounded;
the second gate driver has an enable control terminal connected to a node between the second terminal of the second pull-down switch and the second resistor to receive a second enable signal, and a power supply terminal for receiving the internal total voltage signal;
the second gate driver has a first control terminal connected to each of the gate of the primary N-channel MOSFET in the first switch module and the gate of the secondary N-channel MOSFET in the first switch module, and a second control terminal connected to each of the source of the primary N-channel MOSFET in the first switch module and a source of the secondary N-channel MOSFET in the first switch module;
the first OR gate has a first input terminal connected to a first switch module control terminal of the MCU module to receive a first control signal, a second input terminal connected to the output terminal of the short-circuit protection device to receive the latch signal, and an output terminal connected to a first terminal of the first pull-down switch;
the first pull-down switch has a second terminal connected to the second operating power supply through the first resistor, and a third terminal grounded;
the first gate driver has an enable control terminal connected to a node between the second terminal of the first pull-down switch and the first resistor to receive a first enable signal, and a power supply terminal for receiving the internal total voltage signal; and
the first gate driver has a first control terminal connected to each of the gate of the primary N-channel MOSFET in the second switch module and the gate of the secondary N-channel MOSFET in the second switch module, and a second control terminal connected to each of the source of the primary N-channel MOSFET in the second switch module and a source of the secondary N-channel MOSFET in the second switch module.

14. The low-voltage lithium battery circuitry according to claim 9, wherein the first drive module comprises a first OR gate, a first pull-down switch, a first gate driver, and a first resistor;
the second drive module comprises a second OR gate, a second pull-down switch, a second gate driver, and a second resistor;
the second OR gate has a first input terminal connected to the second switch module control terminal of the MCU module to receive the second control signal, a second input terminal connected to the output terminal of the short-circuit protection device to receive the latch signal, and an output terminal connected to a first terminal of the second pull-down switch;
the second pull-down switch has a second terminal connected to a second operating power supply through the second resistor, and a third terminal grounded;
the second gate driver has an enable control terminal connected to a node between the second terminal of the second pull-down switch and the second resistor to receive a second enable signal, and a power supply terminal for receiving the internal total voltage signal;
the second gate driver has a first control terminal connected to each of the respective gates of the number of secondary N-channel MOSFETs in the second switch module, and a second control terminal connected to each of the respective sources of the number of secondary N-channel MOSFETs in the second switch module;
the first OR gate has a first input terminal connected to the first switch module control terminal of the MCU module to receive the first control signal, a second input terminal connected to the output terminal of the short-circuit protection device to receive the latch signal, and an output terminal connected to a first terminal of the first pull-down switch;
the first pull-down switch has a second terminal connected to the second operating power supply through the first resistor, and a third terminal grounded;
the first gate driver has an enable control terminal connected to a node between the second terminal of the first pull-down switch and the first resistor to receive a first enable signal, and a power supply terminal for receiving the internal total voltage signal; and
the first gate driver has a first control terminal connected to each of the respective gates of the number of primary N-channel MOSFETs in the first switch module, and a second control terminal connected to each of the respective sources of the number of primary N-channel MOSFETs in the first switch module.

15. A protection method for a low-voltage lithium battery, applicable to a low-voltage lithium battery circuitry comprising a busbar, a battery signal transmitter unit, a battery management system, and a lithium battery module,
wherein the battery signal transmitter unit is connected to each of the lithium battery module and the battery management system;
the lithium battery module is connected to the battery management system through a first port of the busbar and a third port of the busbar;
the battery management system is connected to a positive terminal of a battery system through a second port of the busbar and connected to a negative terminal of the battery system through a fourth port of the busbar; and
the protection method comprises:
the lithium battery module acquiring electrical parameters in the lithium battery module, wherein the electrical parameters comprise an internal total voltage signal, cell voltage signals, and battery temperature signals;
the battery signal transmitter unit transmitting the electrical parameters to the battery management system; and
in response to determining that any one of the electrical parameters exceeds a protection threshold range corresponding to the any one of the electrical parameters, the battery management system performing a protection operation.

16. The protection method according to claim 15, wherein the battery management system comprises a sampling circuit, an MCU module, and a communication device; and
the battery management system performing the protection operation in response to determining that the any one of the electrical parameters exceeds the protection threshold range comprises:
the sampling circuit receiving the internal total voltage signal, the cell voltage signals, and the battery temperature signals, acquiring a total voltage signal, a current sampling signal, and a MOSFET temperature signal in the low-voltage lithium battery circuitry, and transmitting the internal total voltage signal, the cell voltage signals, the total voltage signal, the battery temperature signals, the current sampling signal, and the MOSFET temperature signal to the MCU module after collecting and filtering the internal total voltage signal, the cell voltage signals, the total voltage signal, the battery temperature signals, the current sampling signal, and the MOSFET temperature signal;
the MCU module generating a fault alarm signal in response to determining at least one of: any of the cell voltage signals being greater than an overvoltage threshold, the total voltage signal being greater than the overvoltage threshold, the internal total voltage signal being greater than the overvoltage threshold, the internal total voltage signal being less than an undervoltage threshold, any of the cell voltage signals being less than the undervoltage threshold, the total voltage signal being less than the undervoltage threshold, any of the battery temperature signals being greater than a battery overtemperature threshold, the MOSFET temperature signal being greater than the battery overtemperature threshold, or the current sampling signal being greater than an overcurrent threshold; and
the communication device communicating with each of the MCU module and an electronic control unit of a vehicle through a communication bus to send the fault alarm signal to the electronic control unit and receive a control signal from the electronic control unit to cause the MCU module to update protection thresholds comprising the overcurrent threshold, the battery overtemperature threshold, the overvoltage threshold, and the undervoltage threshold.

17. The protection method according to claim 16, wherein the battery management system further comprises a first switch module and a second switch module; and
the protection method further comprises: when the lithium battery module is in a charging state,
in response to determining at least one of: any of the cell voltage signals being greater than the overvoltage threshold, or the total voltage signal being greater than the overvoltage threshold, the MCU module determining that charging overvoltage has occurred and generating a charging overvoltage alarm signal; and
the MCU module controlling, based on the charging overvoltage alarm signal, the second switch module to be turned on and the first switch module to be turned off, so that a main loop is turned off and prevented from charging and enters a discharging maintaining state to implement an overcharge protection function.

18. The protection method according to claim 16, wherein the battery management system further comprises a shunt and a filter;
the shunt has a first terminal connected to a negative terminal of the lithium battery module through the third port of the busbar, and a second terminal connected to the negative terminal of the battery system through the fourth port of the busbar;
the filter has two terminals respectively connected to the first terminal and the second terminal of the shunt; and
the protection method further comprises:
the shunt outputting two current differential signals; and
the filter filtering the two current differential signals to obtain the current sampling signal, and transmitting the current sampling signal to a current sampling port of the sampling circuit, so as to determine, by comparing the current sampling signal with the overcurrent threshold, whether overcurrent has occurred.

19. The protection method according to claim 18, wherein the battery management system further comprises a short-circuit protection device comprising an operational amplifier unit, a comparator unit, and a signal latch unit;
the operational amplifier unit has two input terminals respectively connected to the first terminal and the second terminal of the shunt, the comparator unit is connected to an output terminal of the operational amplifier unit, and the signal latch unit is connected to the comparator unit; and
the protection method further comprises:
the operational amplifier unit amplifying the two current differential signals;
the comparator unit performing comparison based on the amplified two current differential signals to output a comparison result; and
the signal latch unit outputting a latch signal based on the comparison result.

20. The protection method according to claim 19, wherein the battery management system further comprises an SBC power module having a wake-up IO port connected to each of a fault trigger unit of the sampling circuit and the signal latch unit of the short-circuit protection device; and
the protection method further comprises at least one of:
upon receiving, through the wake-up IO port, a fault wake-up signal from the fault trigger unit, waking up the SBC power module; or
during a sleep period of the SBC power module, the short-circuit protection device maintaining in an operating state and, upon triggering short-circuit protection, sending the latch signal to the wake-up IO port for waking up the SBC power module to enter an operating state.
